(19) United States
(12) Patent Application Publication
(10) Pub. No.: US 2026/0176391 A1
(43) Pub. Date: Jun. 25, 2026

(54) OLEFIN POLYMERIZATION CATALYST AND METHOD FOR PRODUCING OLEFIN POLYMER

(71) Applicant: TOHO TITANIUM CO., LTD., Chigasaki-shi (JP)

(72) Inventors: Christopher Garland Bauch, Chigasaki-shi (JP); Teppei Ishikawa, Chigasaki-shi (JP); Ryoko Oizumi, Chigasaki-shi (JP)

(73) Assignee: TOHO TITANIUM CO., LTD., Chigasaki-shi (JP)

(21) Appl. No.: 18/987,150

(22) Filed: Dec. 19, 2024

(51) Int. Cl. C08F 210/16

(52) U.S. Cl. CPC C08F 210/16; C08F 2410/01

(57) ABSTRACT

Provided is an olefin polymerization catalyst including: (I) a solid catalyst component for olefin polymerization containing at least magnesium, titanium, halogen, and as an internal electron-donating compound, one or more compounds selected from succinate diester compounds and one or more compounds selected from phthalate diester compounds; (II) an organoaluminum compound; and (III) as an external electron-donating compound, at least one or more compounds selected from alkoxysilane compounds and one or more compounds selected from (alkylamino)alkylsilane compounds. According to the present invention, an olefin polymerization catalyst that can produce an olefin polymer having a high flexural modulus and a high impact resistance, and a method for producing an olefin polymer using the catalyst can be provided.

### TECHNICAL FIELD

The present invention relates to an olefin polymerization catalyst and to a method for producing an olefin polymer using the catalyst.

### BACKGROUND ART

In recent years, olefin polymers such as polypropylene (PP) have been used for various applications such as containers and film, as well as for molded articles such as automotive parts and home appliances.

Polypropylene resin is a material of significant importance in numerous fields due to its advantageous characteristics. These include its lightweight nature, excellent moldability, and high chemical stability, particularly with regard to heat and chemicals when molded. Additionally, it offers an optimal cost-performance ratio.

Traditionally, for the production of an olefin polymer such as polypropylene with a high flexural modulus, the olefin has been polymerized using an olefin polymerization catalyst containing 2,3-diisopropylsuccinate diester as an internal electron donor.

For example, in Patent Literature Example 1, it is described that propylene was polymerized using 2,3-diisopropylsuccinate ethyl ester as the internal electron donor.

### CITATION LIST

### Patent Literature

Patent Literature 1: Japanese Patent Publication No. 2013-533367

### SUMMARY OF INVENTION

### Technical Problem

However, in a homopolymer of an olefin or a copolymer of ethylene and propylene, which is required to have a high impact resistance, when homo-polymerization of an olefin or copolymerization of ethylene and propylene is carried out by using an olefin polymerization catalyst containing, as a solid catalyst component, a solid catalyst component for olefin polymerization containing diethyl succinate as an internal electron-donor compound, the use of the succinate diester compound increases a flexural modulus, but decreases a melt flowability thereof. Therefore, to obtain a homopolymer or a copolymer having a practical melt flowability using the succinate diester compound as the internal electron-donating compound, the amount of hydrogen to be used during polymerization needs to be increased. In so doing, however, there has been a problem of the decrease in an impact resistance.

In other words, in the polymerization of an olefin using an olefin polymerization catalyst, there is a strong tendency of a trade-off relationship between the flexural modulus and the impact resistance of the resulting olefin copolymer, so that it has been difficult to obtain an olefin polymer that satisfies both the flexural modulus and the impact resistance.

Therefore, an object of the present invention is to provide an olefin polymerization catalyst and a method for producing an olefin polymer using the catalyst that is able to produce an olefin polymer having a higher flexural modulus and a higher impact resistance than those obtained using a conventional olefin polymerization catalyst when compared under the same polymerization condition.

### Solution to Problem

In order to solve the above technical problem, the inventors of the present invention have carried out an extensive investigation; as a result it has been found that when a succinate diester compound and a phthalate diester compound are used as the internal electron-donating compounds in the solid catalyst component for olefin polymerization, both of which constitute the olefin polymerization catalyst, in combination with an alkoxysilane compound and an (alkylamino)alkylsilane compound as an external electron-donating compound, a sufficient melt flowability can be obtained even when the amount of hydrogen used during the polymerization is low, and therefore, an amount of a high molecular weight polymer can be increased and an amount of a low molecular weight polymer can be reduced, and also an olefin polymer having a higher flexural modulus and a higher impact resistance than those obtained using a conventional olefin polymerization catalyst when compared under the same polymerization condition can be obtained, thus the present invention has been completed base on this finding.

In other words, the present invention provides the following:
(1) an olefin polymerization catalyst including:
   (I) a solid catalyst component for olefin polymerization containing at least magnesium, titanium, halogen, and as an internal electron-donating compound, at least one or more compounds selected from succinate diester compounds represented by the following general formula (1):

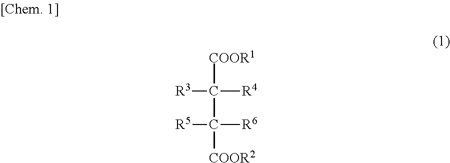

(in the formula, R¹ and R² each, which are optionally identical or different from each other, independently represent a linear alkyl group having the carbon number of 1 to 12, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20; R³, R⁴, R⁵, and R⁶ each, all of which are optionally identical or different from each other, independently represent an atom or a group selected from a hydrogen atom, a halogen atom, a linear alkyl group having the carbon number of 1 to 12, a branched alkyl group having the carbon number of 3 to 12, a vinyl group, a linear or a branched alkenyl group having the carbon number of 3 to 12, a linear or a branched halogen-substituted alkyl group having the carbon number of 2 to 12, a cycloalkyl group having the carbon number of 3 to 12, a cycloalkenyl group having the carbon number of 3 to 12, an aromatic hydrocarbon group having the carbon number of 6 to 20, a nitrogen-containing group, a phosphorus-containing group, and a silicon-containing group), and
one or more compounds selected from phthalate diester compounds represented by the following general formula (2):

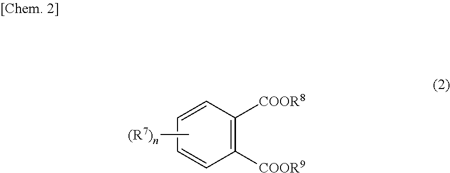

(in the formula, R⁷ represents an alkyl group having the carbon number of 1 to 8 or a halogen atom, R⁸ and R⁹, which are optionally identical or different from each other, represent an alkyl group having the carbon number of 1 to 12, and the number n of the substituent R⁷ represents 0, 1, or 2, in which when n is 2, these R⁷ are optionally identical or different from each other);
(II) an organoaluminum compound; and
(III) as an external electron-donating compound, at least one or more compounds selected from alkoxysilane compounds represented by the following general formula (3):

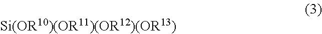

(in the formula, R¹⁰, R¹¹, R¹², and R¹³, all of which are optionally identical or different from each other, represent a linear alkyl group having the carbon number of 1 to 8 or a branched alkyl group having the carbon number of 3 to 8), and one or more compounds selected from (alkylamino)alkylsilane compounds represented by the following general formula (4):

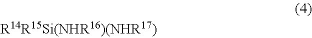

(in the formula, R¹⁴ and R¹⁵, which are optionally identical or different from each other, represent a linear alkyl group having the carbon number of 1 to 8, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20; and R¹⁶ and R¹⁷, which are optionally identical or different from each other, represent an alkyl group having the carbon number of 1 to 8);
(2) the olefin polymerization catalyst according to (1), in which the succinate diester compound represented by the general formula (1) is at least one selected from the group consisting of diethyl succinate, diethyl 2,3-dimethylsuccinate, diethyl 2,3-diethylsuccinate, diethyl 2,3-di-n-propylsuccinate, diethyl 2,3-di-n-butylsuccinate, diethyl 2,3-di-n-butylsuccinate, diethyl 2,3-diethyl 2,3-diisopropylsuccinate, diisobutylsuccinate, diisobutyl 2,3-diisopropylsuccinate, di-n-butyl 2,3-diisopropylsuccinate, diethyl 2,3-dicyclohexyl-2-methylsuccinate, diisobutyl 2,3-dicyclohexyl-2-methylsuccinate, diethyl 2,3-diisopropyl-2-cyanosuccinate, di-n-butyl 2,3-diisopropyl-2-cyanosuccinate, di-n-butyl 2,3-diisopropyl-2-cyanosuccinate, diisobutyl 2,3-diisopropyl-2-cyanosuccinate, diethyl 2,3-dicyclopentyl-2-cyanosuccinate, di-n-butyl 2,3-dicyclopentyl-2-cyanosuccinate, diisobutyl 2,3-dicyclopentyl-2-cyanosuccinate, diethyl 2,3-dicyclohexyl-2-cyanosuccinate, di-n-butyl 2,3-dicyclohexyl-2-cyanosuccinate, diisobutyl 2,3-dicyclohexyl-2-cyanosuccinate, diethyl 2-cyclopentyl-3-cyclohexyl-2-cyanosuccinate, 1-isobutyl 4-ethyl 2,3-diisopropyl-2-cyanosuccinate, 1-n-butyl 4-ethyl 2,3-diisopropyl-2-cyanosuccinate, diethyl 2-isopropyl-3-methyl-2-cyanosuccinate, diethyl 2-isopropyl-3-ethyl-2-cyanosuccinate, diethyl 2-isopropyl-3-n-propyl-2-cyanosuccinate, diethyl 2-isopropyl-3-butyl-2-cyanosuccinate, diethyl 2-isopropyl-3-phenyl-2-cyanosuccinate, diethyl 2-cyclohexyl-3-isopropyl-2-cyanosuccinate, and 1-ethyl 4-isobutyl 2-isopropyl-3-phenyl-2-cyanosuccinate;
(3) the olefin polymerization catalyst according to (1), in which the phthalate diester compound represented by the general formula (2) is at least one selected from the group consisting of dimethyl phthalate, diethyl phthalate, di-n-propyl phthalate, diisopropyl phthalate, di-n-butyl phthalate, diisobutyl phthalate, ethyl methyl phthalate, methyl (isopropyl) phthalate, ethyl (n-propyl) phthalate, ethyl (n-butyl) phthalate, ethyl (isobutyl) phthalate, di-n-pentyl phthalate, diisopentyl phthalate, dineopentyl phthalate, dihexyl phthalate, di-n-heptyl phthalate, di-n-octyl phthalate, bis(2,2-dimethylhexyl) phthalate, bis(2-ethylhexyl) phthalate, di-n-nonyl phthalate, di-isodecyl phthalate, bis(2,2-dimethylheptyl) phthalate, n-butyl (isohexyl) phthalate, n-butyl(2-ethylhexyl) phthalate, n-pentyl hexyl phthalate, n-pentyl (isohexyl) phthalate, isopentyl (heptyl) phthalate, n-pentyl(2-ethylhexyl) phthalate, n-pentyl (isononyl) phthalate, isopentyl (n-decyl) phthalate, n-pentyl undecyl phthalate, isopentyl (isohexyl) phthalate, n-hexyl (2,2-dimethylhexyl) phthalate, n-hexyl(2-ethylhexyl) phthalate, n-hexyl (isononyl) phthalate, n-hexyl (n-decyl) phthalate, n-heptyl(2-ethylhexyl) phthalate, n-heptyl (isononyl) phthalate, n-heptyl (neodecyl) phthalate, and 2-ethylhexyl (isononyl) phthalate;
(4) the olefin polymerization catalyst according to (1), in which the alkoxysilane compound represented by the general formula (3) is at least one selected from the group consisting of tetramethoxysilane, tetraethoxysilane, tetrapropoxysilane, tetraisopropoxysilane, tetrabutoxysilane, and tetrakis (2-ethylhexyloxy) silane;
(5) the olefin polymerization catalyst according to (1), in which the (alkylamino)alkylsilane compound represented by the general formula (4) is at least one selected from the group consisting of diisopropyl bis(ethylamino) silane, dicyclopentyl bis(ethylamino) silane, dicyclohexyl bis(ethylamino) silane, cyclohexylmethyl bis(ethylamino) silane, and cyclohexylcyclopentyl bis(ethylamino) silane;
(6) the olefin polymerization catalyst according to (1), in which a molar ratio (Y/X) of a content (Y) of the (alkylamino)alkylsilane compound represented by the general formula (4) to a content (X) of the alkoxysilane compound represented by the general formula (3) is from 1/99 to 50/50; and
(7) a method for producing an olefin polymer, the method including polymerizing an olefin using the olefin polymerization catalyst according to (1).

### Advantageous Effect of Invention

According to the present invention, an olefin polymerization catalyst that can produce an olefin polymer having a high flexural modulus and a high impact resistance as compared with those obtained using a conventional olefin polymerization catalyst when compared under the same polymerization condition; and a method for producing an olefin polymer using the catalyst can be provided.

### DESCRIPTION OF EMBODIMENTS

The olefin polymerization catalyst according to the present invention includes:
(I) a solid catalyst component for olefin polymerization containing at least magnesium, titanium, halogen, and as an internal electron-donating compound, at least one or more compounds selected from succinate diester compounds represented by the following general formula (1):

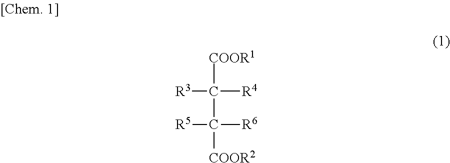

(in the formula, R¹ and R² each, which are optionally identical or different from each other, independently represent a linear alkyl group having the carbon number of 1 to 12, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20; R³, R⁴, R⁵, and R⁶ each, all of which are optionally identical or different from each other, independently represent an atom or a group selected from a hydrogen atom, a halogen atom, a linear alkyl group having the carbon number of 1 to 12, a branched alkyl group having the carbon number of 3 to 12, a vinyl group, a linear or a branched alkenyl group having the carbon number of 3 to 12, a linear or a branched halogen-substituted alkyl group having the carbon number of 2 to 12, a cycloalkyl group having the carbon number of 3 to 12, a cycloalkenyl group having the carbon number of 3 to 12, an aromatic hydrocarbon group having the carbon number of 6 to 20, a nitrogen-containing group, a phosphorus-containing group, and a silicon-containing group), and
one or more compounds selected from phthalate diester compounds represented by the following general formula (2):

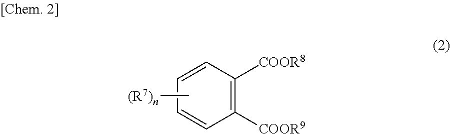

(in the formula, R⁷ represents an alkyl group having the carbon number of 1 to 8 or a halogen atom, R⁸ and R⁹, which are optionally identical or different from each other, represent an alkyl group having the carbon number of 1 to 12, and the number n of the substituent R⁷ represents 0, 1, or 2, in which when n is 2, these R⁷ are optionally identical or different from each other);
(II) an organoaluminum compound; and
(III) as an external electron-donating compound, at least one or more compounds selected from alkoxysilane compounds represented by the following general formula (3):

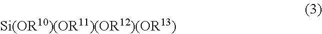

(in the formula, R¹⁰, R¹¹, R¹², and R¹³, all of which are optionally identical or different from each other, represent a linear alkyl group having the carbon number of 1 to 8 or a branched alkyl group having the carbon number of 3 to 8), and
one or more compounds selected from (alkylamino)alkylsilane compounds represented by the following general formula (4):

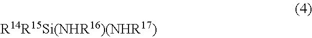

(in the formula, R¹⁴ and R¹⁵, which are optionally identical or different from each other, represent a linear alkyl group having the carbon number of 1 to 8, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20; and R¹⁶ and R¹⁷, which are optionally identical or different from each other, represent an alkyl group having the carbon number of 1 to 8).

In other words, the olefin polymerization catalyst according to the present invention includes:
(I) at least magnesium, titanium, halogen, and as the solid catalyst component for olefin polymerization containing the internal electron-donating group, at least a solid catalyst component for olefin polymerization containing a succinate diester compound and a phthalate diester compound;
(II) an organoaluminum compound; and
(III) as the external electron-donating compound, at least one or more compounds selected from alkoxysilane compounds represented by the general formula (3) and one or more compounds selected from (alkylamino)alkylsilane compounds represented by the general formula (4).

The olefin polymerization catalyst according to the present invention includes (I) as the solid catalyst component for olefin polymerization, the solid catalyst component for olefin polymerization containing at least the succinate diester compound and the phthalate diester compound.

The solid catalyst component for olefin polymerization containing the succinate diester compound and the phthalate diester compound that is related to the olefin polymerization catalyst according to the present invention is the solid catalyst component for olefin polymerization containing at least magnesium, titanium, halogen, and as the internal electron-donating compound, at least the succinate diester compound represented by the general formula (1) and the phthalate diester compound represented by the general formula (2). The solid catalyst component for olefin polymerization containing the succinate diester compound and the phthalate diester compound is the solid catalyst component having both the succinate diester compound and the phthalate diester compound supported in the solid catalyst component.

The solid catalyst component for olefin polymerization containing the succinate diester compound and the phthalate diester compound may include a contact-reaction product obtained by the reaction in which a raw material component as the source of magnesium, a raw material component as the source of titanium and halogen, and the succinate diester compound and the phthalate diester compound, which are the internal electron-donating compounds, are brought into mutual contact in an organic solvent to cause the reaction. Specifically, the catalyst component may include a contact-reaction product in which as the raw material components, a dialkoxymagnesium is used as the source of magnesium and a tetravalent titanium halide compound is used as the source of titanium and halogen, and then, these are brought into mutual contact with the internal electron-donating compound including the succinate diester compound and the internal electron-donating compound including the phthalate diester compound.

In the solid catalyst component for olefin polymerization containing the succinate diester compound and the phthalate diester compound, the dialkoxymagnesium, which is the raw material component as the source of magnesium, is one or more compounds selected from a magnesium dihalide, a dialkylmagnesium, an alkylmagnesium halide, a dialkoxymagnesium, a diaryloxymagnesium, an alkoxymagnesium halide, and a magnesium fatty acid. Among these magnesium compounds, a magnesium dihalide, a mixture of a magnesium dihalide and a dialkoxymagnesium, and a dialkoxymagnesium are preferable; a dialkoxymagnesium is especially preferable.

Illustrative examples of the dialkoxymagnesium may include dimethoxymagnesium, diethoxymagnesium, dipropoxymagnesium, dibutoxymagnesium, ethoxymethoxymagnesium, ethoxypropoxymagnesium, and butoxyethoxymagnesium. These dialkoxymagnesium compounds may also be the one that is obtained by reacting a metallic magnesium with an alcohol in the presence of a halogen or a halogen-containing metal compound. The dialkoxymagnesium may be used singly or in a combination of those described above.

The dialkoxymagnesium is preferably in a granular form or in a powder form; its shape may be irregular or spherical.

When the dialkoxymagnesium having a spherical shape is used, a polymer powder having a better particle shape (more spherical) and a narrow particle size distribution may be obtained, so that the handling operability of the resulting polymer powder during the polymerization operation is improved; thus, for example, the occurrence of blockage caused by fine powders in the produced polymer powder can be suppressed.

The spherical dialkoxymagnesium is not necessarily be true spherical; the spherical dialkoxymagnesium with an oval shape or a potato-like shape may also be used. Specifically, the particle shape thereof in terms of the ratio of the major axis diameter 1 to the minor axis diameter w (l/w) is 3 or less, preferably from 1 to 2, and more preferably from 1 to 1.5.

The average particle diameter (average particle diameter D50) of the dialkoxymagnesium is preferably from 1.0 to 200.0 μm, and more preferably from 5.0 to 150.0 μm. Here, the average particle diameter D50 means the particle diameter of 50% in terms of the integrated particle size distribution on the volume basis when being measured using a particle size analyzer based on a laser light scattering diffraction method.

When the dialkoxymagnesium is spherical, the average particle diameter D50 thereof is preferably from 1.0 to 100.0 μm, more preferably from 5.0 to 80.0 μm, and still more preferably from 10.0 to 70.0 μm.

As for the particle size distribution of the dialkoxymagnesium, the particle size distribution thereof is preferably narrow with a few fine and coarse particles.

Specifically, when measured using a particle size analyzer based on a laser light scattering diffraction method, the content of the dialkoxymagnesium having the particle diameter of 5.0 μm or less is preferably 20% or less, and more preferably 10% or less. On the other hand, when measured using a particle size analyzer based on a laser light scattering diffraction method, the content of the particle having the particle diameter of 100.0 μm or more is preferably 20% or less, and more preferably 10% or less.

Furthermore, when expressed by ln(D90/D10), the particle size distribution thereof is preferably 3 or less, and more preferably 2 or less. Here, D90 means the particle diameter of 90% in terms of the integrated particle size distribution on the volume basis when measured using a particle size analyzer based on a laser light scattering diffraction method. Also, D10 means the particle diameter of 10% in terms of the integrated particle size distribution on the volume basis when measured using a particle size analyzer based on a laser light scattering diffraction method.

Examples of the method for producing the above-mentioned spherical dialkoxymagnesium include Japanese Patent Publication No. S62-51633, Japanese Patent Publication No. H03-74341, Japanese Patent Publication No. H04-368391, and Japanese Patent Publication No. H08-73388.

The specific surface area of the dialkoxymagnesium is preferably 5 m²/g or more, more preferably from 5 to 50 m²/g, and still more preferably from 10 to 40 m²/g.

When the dialkoxymagnesium having the specific surface area within the above range is used, the solid catalyst component for olefin polymerization having an intended specific surface area may be readily prepared.

In this specification, the specific surface area of the dialkoxymagnesium means the value measured by a BET method. Specifically, this means the value measured by the BET method (automatic measurement) in the presence of a mixture of nitrogen and helium gases using Automatic Surface Area Analyzer HM model-1230 (manufactured by Mountech Co., Ltd.) after vacuum drying the sample at 50° C. for 2 hours.

The dialkoxymagnesium is preferably in solution or suspension at the time of reaction, because the reaction may take place suitably in solution or suspension.

When the dialkoxymagnesium is solid, it can be made to a solution thereof by dissolving it in a solvent that can dissolve the dialkoxymagnesium, or it can be made to a suspension thereof by suspending it in a solvent that cannot dissolve the dialkoxymagnesium.

In the case when the dialkoxymagnesium is a liquid, it may be used as it is as a solution of the dialkoxymagnesium, or it may be further dissolved in a solvent that can dissolve the dialkoxymagnesium; and this may be used as the dialkoxymagnesium solution.

The compound that can dissolve the solid dialkoxymagnesium may include at least one compound selected from the group consisting of an alcohol, an ether, and an ester. Among these, an alcohol such as ethanol, propanol, butanol, and 2-ethylhexanol is preferable, and 2-ethylhexanol is especially preferable.

On the other hand, the medium that cannot dissolve the solid dialkoxymagnesium may include one or more solvents selected from a saturated hydrocarbon solvent and an unsaturated hydrocarbon solvent, which cannot dissolve the dialkoxymagnesium.

In the solid catalyst component for olefin polymerization containing the succinate diester compound and the phthalate diester compound, there is no particular restriction in the tetravalent titanium halide compound, which is the raw material component as the source of titanium and halogen. However, it is preferable to use one or more compounds selected from the group consisting of a titanium halide and an alkoxytitanium halide represented by the following general formula (5):

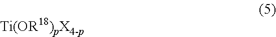

(in the formula, R¹⁸ represents an alkyl group having the carbon number of 1 to 4; X represents a halogen atom such as a chlorine atom, a bromine atom, and an iodine atom; and p represents the number of 0≤p≤3).

In the general formula (5), p represents the number of 0≤p≤3; specifically, p is 0, 1, 2, or 3.

The titanium halide represented by the general formula (5) may include one or more titanium tetrahalides selected from titanium tetrachloride, titanium tetrabromide, and titanium tetraiodide.

The alkoxytitanium halide represented by the general formula (5) may include one or more compounds selected from methoxytitanium trichloride, ethoxytitanium trichloride, propoxytitanium trichloride, n-butoxytitanium trichloride, dimethoxytitanium dichloride, diethoxytitanium dichloride, dipropoxytitanium dichloride, di-n-butoxytitanium dichloride, trimethoxytitanium chloride, triethoxytitanium chloride, tripropoxytitanium chloride, and tri-n-butoxytitanium chloride.

As for the tetravalent titanium halide compound, a titanium tetrahalide is preferable; titanium tetrachloride is more preferable.

These titanium compounds may be used singly or in a combination of two or more of those described above.

The solid catalyst component for olefin polymerization containing the succinate diester compound and the phthalate diester compound contains, as the internal electron-donating compound, at least one compounds selected from succinate diester compound represented by the following general formula (1):

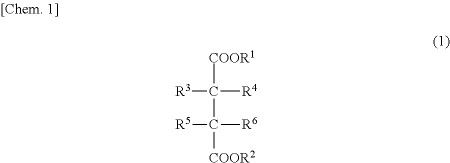

(in the formula, R¹ and R² each, which are optionally identical or different from each other, independently represent a linear alkyl group having the carbon number of 1 to 12, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20; R³, R⁴, R⁵, and R⁶ each, all of which are optionally identical or different from each other, independently represent an atom or a group selected from a hydrogen atom, a halogen atom, a linear alkyl group having the carbon number of 1 to 12, a branched alkyl group having the carbon number of 3 to 12, a vinyl group, a linear or a branched alkenyl group having the carbon number of 3 to 12, a linear or a branched halogen-substituted alkyl group having the carbon number of 2 to 12, a cycloalkyl group having the carbon number of 3 to 12, a cycloalkenyl group having the carbon number of 3 to 12, an aromatic hydrocarbon group having the carbon number of 6 to 20, a nitrogen-containing group, a phosphorus-containing group, and a silicon-containing group).
The presence of the succinate diester compound represented by the general formula (1) as the internal electron-donating compound in the olefin polymerization catalyst is desirable because it allows to increase the formation of a high molecular weight polymer upon polymerization, resulting in the increase in a flexural modulus.

In the succinate diester compound represented by the general formula (1), R¹ and R² each, which are optionally identical or different from each other, independently represent a linear alkyl group having the carbon number of 1 to 12, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20.

When R¹ and R² represent an alkyl group having the carbon number of 1 to 4, the alkyl group thereof may include specifically a methyl group, an ethyl group, an n-propyl group, an isopropyl group, an n-butyl group, or an isobutyl group.

In the succinate diester compound represented by the general formula (1), R³, R⁴, R⁵, and R⁶ each, all of which are optionally identical or different from each other, independently represent an atom or a group selected from a hydrogen atom, a halogen atom, a linear alkyl group having the carbon number of 1 to 12, a branched alkyl group having the carbon number of 3 to 12, a vinyl group, a linear or a branched alkenyl group having the carbon number of 3 to 12, a linear or a branched halogen-substituted alkyl group having the carbon number of 2 to 12, a cycloalkyl group having the carbon number of 3 to 12, a cycloalkenyl group having the carbon number of 3 to 12, an aromatic hydrocarbon group having the carbon number of 6 to 20, a nitrogen-containing group, a phosphorus-containing group, and a silicon-containing group.

When R³, R⁴, R⁵, and R⁶ represent a linear alkyl group having the carbon number of 1 to 12 or a branched alkyl group having the carbon number of 3 to 12, the alkyl group may include specifically an ethyl group, an n-propyl group, an isopropyl group, an n-butyl group, or an isobutyl group.

When R³, R⁴, R⁵, and R⁶ represent a nitrogen-containing group, the nitrogen-containing group may include specifically an amino group and a cyano group.

In the solid catalyst component for olefin polymerization containing the succinate diester compound and the phthalate diester compound, there is no particular restriction in the succinate diester compound represented by the general formula (1). Therefore, the solid catalyst component for olefin polymerization may include one or more compounds selected from
diethyl succinate, diethyl 2,3-dimethylsuccinate, diethyl 2,3-diethylsuccinate, diethyl 2,3-di-n-propylsuccinate, diethyl 2,3-diisopropylsuccinate, diethyl 2,3-di-n-butylsuccinate, diethyl 2,3-diisobutylsuccinate;
di-n-propyl succinate, di-n-propyl 2,3-dimethylsuccinate, di-n-propyl 2,3-diethylsuccinate, di-n-propyl 2,3-di-n-propylsuccinate, di-n-propyl 2,3-diisopropylsuccinate, di-n-propyl 2,3-di-n-butylsuccinate, di-n-propyl 2,3-diisobutylsuccinate;
diisopropyl succinate, diisopropyl 2,3-dimethylsuccinate, diisopropyl 2,3-diethylsuccinate, diisopropyl 2,3-di-n-propylsuccinate, diisopropyl 2,3-diisopropylsuccinate, diisopropyl 2,3-di-n-butylsuccinate, diisopropyl 2,3-diisobutylsuccinate;
di-n-butyl succinate, di-n-butyl 2,3-dimethylsuccinate, di-n-butyl 2,3-diethylsuccinate, di-n-butyl 2,3-di-n-propylsuccinate, di-n-butyl 2,3-diisopropylsuccinate, di-n-butyl 2,3-di-n-butylsuccinate, di-n-butyl 2,3-diisobutylsuccinate;
diisobutyl succinate, diisobutyl 2,3-dimethylsuccinate, diisobutyl 2,3-diethylsuccinate, diisobutyl 2,3-di-n-propylsuccinate, diisobutyl 2,3-diisopropylsuccinate, diisobutyl 2,3-di-n-butylsuccinate, diisobutyl 2,3-diisobutylsuccinate;

diethyl 2,3-diisopropyl-2-cyanosuccinate, di-n-butyl 2,3-diisopropyl-2-cyanosuccinate, di-n-butyl 2,3-diisopropyl-2-cyanosuccinate, diisobutyl 2,3-diisopropyl-2-cyanosuccinate, diethyl 2,3-dicyclopentyl-2-cyanosuccinate, di-n-butyl 2,3-dicyclopentyl-2-cyanosuccinate, diisobutyl 2,3-dicyclopentyl-2-cyanosuccinate, diethyl 2,3-dicyclohexyl-2-cyanosuccinate, di-n-butyl 2,3-dicyclohexyl-2-cyanosuccinate, diisobutyl 2,3-dicyclohexyl-2-cyanosuccinate, diethyl 2-cyclopentyl-3-cyclohexyl-2-cyanosuccinate, 1-isobutyl 4-ethyl 2,3-diisopropyl-2-cyanosuccinate, 1-n-butyl 4-ethyl 2,3-diisopropyl-2-cyanosuccinate, diethyl 2-isopropyl-3-methyl-2-cyanosuccinate, diethyl 2-isopropyl-3-ethyl-2-cyanosuccinate, diethyl 2-isopropyl-3-n-propyl-2-cyanosuccinate, diethyl 2-isopropyl-3-butyl-2-cyanosuccinate, diethyl 2-isopropyl-3-phenyl-2-cyanosuccinate, diethyl 2-cyclohexyl-3-isopropyl-2-cyanosuccinate, and 1-ethyl 4-isobutyl 2-isopropyl-3-phenyl-2-cyanosuccinate.

Among these, preferably used succinate diesters are diethyl succinate, di-n-propyl succinate, di-n-butyl succinate, diisobutyl succinate, diethyl 2,3-di-n-propylsuccinate, diethyl 2,3-diisopropylsuccinate, di-n-propyl 2,3-di-n-propylsuccinate, di-n-propyl 2,3-diisopropylsuccinate, diisopropyl 2,3-di-n-propylsuccinate, diisopropyl 2,3-diisopropylsuccinate, di-n-butyl 2,3-di-n-propylsuccinate, di-n-butyl 2,3-diisopropylsuccinate, diisobutyl 2,3-di-n-propylsuccinate, diisobutyl 2,3-diisopropylsuccinate, diethyl 2,3-diisopropyl-2-cyanosuccinate, 1-isobutyl 4-ethyl 2,3-diisopropyl-2-cyanosuccinate, diethyl 2-isopropyl-3-methyl-2-cyanosuccinate, diethyl 2-isopropyl-3-ethyl-2-cyanosuccinate, diethyl 2-cyclopentyl-3-isopropyl-2-cyanosuccinate, and di-n-butyl 2,3-diisopropyl-2-cyanosuccinate.

The succinate diester compound represented by the general formula (1) may be used singly or in a combination of two or more of those compounds described above.

The solid catalyst component for olefin polymerization containing the succinate diester compound and the phthalate diester compound contains, as the internal electron-donating compound, at least one compounds selected from phthalate diester compound represented by the following general formula (2):

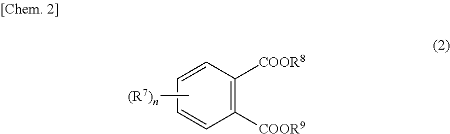

(in the formula, R⁷ represents an alkyl group having the carbon number of 1 to 8 or a halogen atom, R⁸ and R⁹, which are optionally identical or different from each other, represent an alkyl group having the carbon number of 1 to 12, and the number n of the substituent R⁷ represents 0, 1, or 2, in which when n is 2, these R⁷ are optionally identical or different from each other).

The presence of the phthalate diester compound represented by the general formula (2) as the internal electron-donating compound in the olefin polymerization catalyst is preferable because it allows to increase the MFR upon polymerization, resulting in production of a highly flowable polymer.

In the phthalate diester compound represented by the general formula (2), R⁷ represents an alkyl group having the carbon number of 1 to 8, preferably an alkyl group having the carbon number of 1 to 8, or a halogen atom.

When R⁷ is a halogen atom, the halogen atom may include one or more halogen atoms selected from a fluorine atom, a chlorine atom, a bromine atom, and an iodine atom.

When R⁷ is an alkyl group having the carbon number of 1 to 8, the alkyl group having the carbon number of 1 to 8 may include one or more selected from a methyl group, an ethyl group, an n-propyl group, an isopropyl group, an n-butyl group, an isobutyl group, a t-butyl group, an n-pentyl group, an isopentyl group, a neopentyl group, an n-hexyl group, an isohexyl group, a 2,2-dimethylbutyl group, 2,2-dimethylpentyl group, an isooctyl group, and a 2,2-dimethylhexyl group.

R⁷ is preferably a methyl group, a bromine atom, and a fluorine atom; a methyl group and a bromine atom are more preferable.

In the phthalate diester compound represented by the general formula (2), R⁸ and R⁹ are an alkyl group having the carbon number of 1 to 12, preferably the carbon number of 1 to 12, in which they are optionally identical or different from each other.

R⁸ and R⁹ may include an ethyl group, an n-butyl group, an isobutyl group, a t-butyl group, a neopentyl group, an isohexyl, and an isooctyl group; among these, an ethyl group, an n-propyl group, an n-butyl group, an isobutyl group, and a neopentyl group are preferable.

In the phthalate diester compound represented by the general formula (2), n is 1 or 2 as the number of the substituent R⁷. When n is 1, R⁷ is an alkyl group, and when n is 2, these R⁷ are optionally identical or different from each other, in which at least one of them is an alkyl group.

In the solid catalyst component for olefin polymerization containing the succinate diester compound and the phthalate diester compound, there is no particular restriction in the phthalate diester component represented by the general formula (2). Illustrative examples thereof include: phthalate diesters such as dimethyl phthalate, diethyl phthalate, di-n-propyl phthalate, diisopropyl phthalate, di-n-butyl phthalate, diisobutyl phthalate, di-n-pentyl phthalate, diisopentyl phthalate, dineopentyl phthalate, di-n-hexyl phthalate, ditexyl phthalate, methyl ethyl phthalate, (ethyl) n-propyl phthalate, ethyl isopropyl phthalate, (ethyl) n-butyl phthalate, ethyl isobutyl phthalate, (ethyl) n-pentyl phthalate, ethyl isopentyl phthalate, ethyl neopentyl phthalate, and (ethyl) n-hexyl phthalate; halogen-substituted phthalate diesters such as diethyl 4-chlorophthalate, di-n-propyl 4-chlorophthalate, diisopropyl 4-chlorophthalate, di-n-butyl 4-chlorophthalate, diisobutyl 4-chlorophthalate, diethyl 4-bromophthalate, di-n-propyl 4-bromophthalate, diisopropyl 4-bromophthalate, di-n-butyl 4-bromophthalate, and diisobutyl 4-bromophthalate; and alkyl-substituted phthalate diesters such as diethyl 4-methylphthalate, di-n-propyl 4-methylphthalate, diisopropyl 4-methylphthalate, di-n-butyl 4-methylphthalate, and diisobutyl 4-methylphthalate.

The phthalate diester compound represented by the general formula (2) may be used singly or in a combination of two or more of those described above.

Both the succinate diester compound represented by the general formula (1) and the phthalate diester represented by the general formula (2) may be used singly or in a combination of two or more of those compounds described above.

The solid catalyst component for olefin polymerization containing the succinate diester compound and the phthalate diester compound contains as the essential components the succinate diester compound represented by the general formula (1) and the phthalate diester compound represented by the general formula (2) as the internal electron-donating compound. The component, however, may further contain other internal electron-donating compound (hereinafter referred to as “other internal electron-donating compound” as appropriate) as the internal electron-donating compound other than the succinate diester compound and the phthalate diester compound.

Such other internal electron-donating compound may include one or more compounds selected from a carbonate, an acid halide, an acid amide, a nitrile, an acid anhydride, and a carboxylate ester.

Such other internal electron-donating compound may include specifically one or more compounds selected from an ether carbonate compound, as well as carboxylate diesters such as a cycloalkane dicarboxylate diester, a cycloalkene dicarboxylate diester, an alkyl-substituted malonate diester, and a maleate diester.

More specifically, one or more compounds selected from an ether carbonate compound such as (2-ethoxyethyl) methyl carbonate, (2-ethoxyethyl)ethyl carbonate, and (2-ethoxyethyl) phenyl carbonate, as well as a cycloalkane dicarboxylate diester such as dimethyl cyclohexane-1,2-dicarboxylate are more preferable.

In the solid catalyst component for olefin polymerization containing the succinate diester compound and the phthalate diester compound, the content of the succinate diester compound represented by the general formula (1) in the total content of the component in terms of the solid content is from 8.0 to 24.0% by mass, preferably from 12.0 to 22.0% by mass, and more preferably from 14.0 to 20.0% by mass. When the content of the succinate diester compound represented by the general formula (1) in the total content of the component in terms of the solid content is within the above-mentioned range, the molecular weight distribution of the olefin polymer may be made wide in the olefin polymerization, resulting in a higher flexural modulus. On the other hand, when the content of the succinate diester compound represented by the general formula (1) in the total content of the component in terms of the solid content is below the above-mentioned range, the molecular weight distribution is not sufficiently wide, and when it is above the range, the polymerization activity is decreased.

In the solid catalyst component for olefin polymerization containing the succinate diester compound and the phthalate diester compound, the content of the phthalate diester compound represented by the general formula (2) in the total content of the component in terms of the solid content is from 8.0 to 24.0% by mass, preferably from 12.0 to 22.0% by mass, and more preferably from 14.0 to 20.0% by mass. When the content of the phthalate diester compound represented by the general formula (2) in the total content of the component in terms of the solid content is within the above-mentioned range, the molecular weight distribution of the olefin polymer may be made wide in the olefin polymerization, resulting in a higher flexural modulus. On the other hand, when the content of the phthalate diester compound represented by the general formula (2) in the total content of the component in terms of the solid content is below the above-mentioned range, the molecular weight distribution is not sufficiently wide, and when it is above the range, the polymerization activity is decreased.

In the solid catalyst component for olefin polymerization containing the succinate diester compound and the phthalate diester compound, the content of the titanium atom in the total content of the component in terms of the solid content is from 2.0 to 6.0% by mass, preferably from 2.5 to 5.0% by mass, and more preferably from 3.0 to 4.5% by mass.

In the solid catalyst component for olefin polymerization containing the succinate diester compound and the phthalate diester compound, the content of the halogen atom in the total content of the component in terms of the solid content is from 50.0 to 70.0% by mass, preferably from 55.0 to 68.0% by mass, and more preferably from 58.0 to 67.0% by mass.

In the solid catalyst component for olefin polymerization containing the succinate diester compound and the phthalate diester compound, the content of the magnesium atom in the total content of the component in terms of the solid content is from 15.0 to 25.0% by mass, preferably from 16.0 to 23.0% by mass, and more preferably from 16.0 to 22.0% by mass.

The solid catalyst component for olefin polymerization containing the succinate diester compound and the phthalate diester compound is preferably the one that is prepared by contacting the above-mentioned dialkoxymagnesium, titanium halide compound, and succinate diester compound represented by the general formula (1) and phthalate diester compound represented by the general formula (2) in the presence of an inert organic solvent.

In the present invention, the above-mentioned inert organic solvent is preferably the one that can dissolve the titanium halide compound but not the dialkoxymagnesium; specifically, the organic solvent may include one or more solvents selected from: saturated organic compounds such as pentane, hexane, heptane, octane, nonane, decane, cyclohexane, methylcyclohexane, ethylcyclohexane, 1,2-diethylcyclohexane, methylcyclohexene, decalin, and mineral oil; aromatic hydrocarbon compounds such as benzene, toluene, xylene, and ethylbenzene; and halogenated hydrocarbon compounds such as ortho-dichlorobenzene, methylene chloride, 1,2-dichlorobenzene, carbon tetrachloride, and dichloroethane.

As for the inert organic solvent, saturated hydrocarbon compounds or aromatic hydrocarbon compounds that are in a liquid state at room temperature with a boiling point range of about 50 to 200° C. are preferably used. Among these, one or more solvents selected from hexane, heptane, octane, ethylcyclohexane, mineral oil, toluene, xylene, and ethylbenzene are preferable, and one or more solvents selected from hexane, heptane, ethylcyclohexane, and toluene are especially preferable.

In this specification, the content of titanium in the solid catalyst component for olefin polymerization means the value measured the method (redox titration) in accordance with JIS 8311-1997 “Method for determination of titanium in titanium ores”.

In this specification, the content of magnesium in the solid catalyst component for olefin polymerization means the value measured by the EDTA titration method, in which the solid catalyst component for olefin polymerization is dissolved in hydrochloric acid solution and titrated with an EDTA solution.

In this specification, the halogen content in the solid catalyst component for olefin polymerization means the value measured by the silver nitrate titration method, in which the solid catalyst component is treated with a mixed solution of sulfuric acid and pure water to make an aqueous solution, and then a predetermined amount of the resulting mixture is separated and titrated with a silver nitrate standard solution to determine the halogen content.

In this specification, the content of the succinate diester compound and the phthalate diester compound in the solid catalyst component for olefin polymerization and of other internal electron-donating compound added as needed means the value determined by hydrolyzing the solid catalyst component for olefin polymerization, extracting the succinate diester compound and the phthalate diester compound and other internal electron-donating compound added as needed using an aromatic solvent, and measuring the solution by a gas chromatography FID (Flame Ionization Detector) method.

The solid catalyst component for olefin polymerization containing the succinate diester compound and the phthalate diester compound may be suitably produced by the production method of the solid catalyst component for olefin polymerization containing the succinate diester compound and the phthalate diester compound, as described hereunder.

Then, the production method of the solid catalyst component for olefin polymerization containing the succinate diester compound and the phthalate diester compound will be described.

An example of the method for producing the solid catalyst component for olefin polymerization containing the succinate diester compound and the phthalate diester compound may include a method for obtaining the solid catalyst component for olefin polymerization containing the succinate diester compound and the phthalate diester compound, in which the raw material component as the source of magnesium, the raw material component as the source of titanium and halogen, and the succinate diester compound and the phthalate diester compound, which are the internal electron-donating compounds, are brought into mutual contact in an organic solvent to cause the reaction. Specifically, the method thereof may include a method in which a dialkoxymagnesium, which is the raw material component as the source of magnesium, a tetravalent titanium halide compound, which is the raw material component as the source of titanium and halogen, and the internal electron-donating compound including the succinate diester compound represented by the general formula (1) and the internal electron-donating compound including the phthalate diester compound represented by the general formula (2) are brought into mutual contact to obtain the solid catalyst component for olefin polymerization containing the succinate diester compound and the phthalate diester compound.

It is preferable that the mutual contact of each component is carried out with stirring in a vessel equipped with a stirrer in an inert gas atmosphere in which a moisture and other materials are removed.

Regarding the temperature at which the above components are brought into contact, in the case that the components are merely brought into contact and stirred and mixed, or dispersed or suspended for denaturation treatment, there is no particular problem when these components are brought into mutual contact around room temperature; a relatively low temperature range of −20 to 30° C. is preferable. In the case that a solid product is obtained by reacting at a high temperature during mutual contact of these components, a relatively high temperature range of 40 to 130° C. is preferable. When the temperature during the reaction is less than 40° C., the reaction does not proceed sufficiently well, resulting in an inadequate performance of the solid catalyst component thus prepared, and when the temperature is more than 130° C., evaporation of the solvent used takes place more eminently, making the reaction difficult to be controlled properly.

The reaction time after the mutual contact is preferably 1 minute or longer, more preferably 10 minutes or longer, and still more preferably 30 minutes or longer.

Hereunder, more specific examples of the order in which each component is contacted in the production of the solid catalyst component for olefin polymerization containing the succinate diester compound and the phthalate diester compound will be described.
(1) Magnesium compound→internal electron-donating compound→inert organic solvent→tetravalent titanium halide compound→<<intermediate washing→inert organic solvent→tetravalent halide compound>>→final washing
(2) Magnesium compound→inert organic solvent→internal electron-donating compound→tetravalent halide compound→<<intermediate washing→inert organic solvent→tetravalent titanium halide compound>>→final washing
(3) Magnesium compound→tetravalent halide compound→inert organic solvent→internal electron-donating compound→<<intermediate washing→inert organic solvent→internal electron-donating compound→tetravalent titanium halide compound>>→final washing
(4) Magnesium compound→tetravalent titanium halide compound→inert organic solvent→internal electron-donating compound→<<intermediate washing→inert organic solvent→tetravalent titanium halide compound→internal electron-donating compound>>→final washing
(5) Magnesium compound→tetravalent halide compound→inert organic solvent→internal electron-donating compound→<<intermediate washing→inert organic solvent→internal electron-donating compound→tetravalent titanium halide compound>>→final washing
(6) Magnesium compound→inert organic solvent→tetravalent titanium halide compound→internal electron-donating compound→<<intermediate washing→inert organic solvent→tetravalent titanium halide compound→internal electron-donating compound>>→final washing
(7) Magnesium compound→inert organic solvent→internal electron-donating compound→tetravalent titanium halide compound→<<intermediate washing→internal electron-donating compound→inert organic solvent→tetravalent titanium halide compound>>→final washing
(8) Magnesium compound→inert organic solvent→internal electron-donating compound→tetravalent titanium halide compound→<<intermediate washing→internal electron-donating compound→inert organic solvent→tetravalent titanium halide compound>>→final washing.

There is no particular restriction in the order of contacting the succinate diester compound represented by the general formula (1) and the phthalate diester compound represented by the general formula (2), both of which are the internal electron-donating compounds, in the production method of the solid catalyst component for olefin polymerization containing the succinate diester compound and the phthalate diester compound. The succinate diester compound represented by the general formula (1) may be contacted firstly, or the phthalate diester compound represented by the general formula (2) may be contacted firstly, or both may be contacted at the same time. However, as the reaction progresses, the more the dialkoxymagnesium is converted to magnesium chloride by the titanium halide compound, the more difficult it is for the succinate diester compound represented by the general formula (1) to be supported on the solid catalyst component; thus, it is preferable to contact the succinate diester compound represented by the general formula (1) firstly, followed by the phthalate diester compound represented by the general formula (2).

In the above contact examples (1) through (8), “→” means the order of contact. For example, “magnesium compound→internal electron-donating compound” means that the magnesium compound and the internal electron-donating compound are contacted in this order.

In the above contact examples (1) through (8), the processes in the double brackets (<< >>) mean that the processes in the double brackets are repeated multiple times as needed, in which the repeating of the processes in the double brackets further enhances the activity. The tetravalent halide compound and the inert organic solvent used in the process in the double brackets may be newly added or may be the residues from the previous processes. When the tetravalent titanium halide compound is added, the tetravalent titanium halide compound used in the process in the double brackets may be newly added or may be the residual tetravalent halide compound from the previous process.

In the above contact examples (1) through (8), it is preferable to use a liquid hydrocarbon compound at room temperature for the intermediate washing, the final washing, and so forth. It is preferable to wash the product obtained at each contact stage in the process other than the intermediate and final washing processes described in the above contact examples (1) through (8).

An especially preferable preparation method for producing the solid catalyst component for olefin polymerization containing the succinate diester compound and the phthalate diester compound may include the methods described in (2), (4), (6), and the like, namely, suspending a dialkoxymagnesium, i.e., the magnesium compound, in the inert organic solvent such as toluene, heptane, or cyclohexane, and then adding titanium tetrachloride, i.e., the tetravalent titanium halide compound, to the resulting suspension, followed by contacting one or more succinate diester compounds and the phthalate diester compound, i.e., the internal electron-donating compound, in the suspension at the temperature range of −20 to 130° C. before or after contacting with the tetravalent titanium halide compound in the above-mentioned suspension to cause the reaction. In this case, it is preferable to perform the ripening reaction at a low temperature before or after contacting the internal electron-donating compound with the suspension.

After washing (pre-washing), as needed, the solid product obtained in this way with a liquid hydrocarbon compound at room temperature, this is caused to contact with the tetravalent titanium halide compound in the presence of the hydrocarbon compound; then, the intended solid catalyst component for olefin polymerization may be obtained by conducting the reaction treatment at 40 to 130° C., which is then followed by washing (post-washing) of the resulting reaction product with a liquid hydrocarbon compound at room temperature. The above pre-washing and reaction of the resulting pre-washed product with the tetravalent titanium halide compound may be repeated multiple times.

Preferable conditions for the above treatment or washing are as follows.

<Conditions for the Ripening Reaction at Low Temperature Before or After Contact with the Internal Electron-Donating Compound>

The temperature for the low temperature ripening is preferably from −20 to 70° C., more preferably from −10 to 50° C., and still more preferably from −5 to 30° C. The time for the low temperature ripening is preferably from 1 minute to 6 hours, more preferably from 5 minutes to 4 hours, and still more preferably from 10 minutes to 3 hours.

### <Reaction Conditions at the Process Before Intermediate Washing>

The temperature of the reaction among the magnesium compound, the internal electron-donating compounds, and the tetravalent titanium halide compound in the inert organic solvent at the process before the intermediate washing is preferably from 0 to 130° C., more preferably from 40 to 120° C., and still more preferably from 50 to 115° C. The reaction time thereof is preferably from 0.5 to 6 hours, more preferably from 0.5 to 5 hours, and still more preferably from 1 to 4 hours.

### <Washing Conditions in the Intermediate Washing and the Final Washing>

The washing temperature is preferably from 0 to 110° C., more preferably from 30 to 100° C., and still more preferably from 30 to 90° C. The repeat number of the washing is preferably from 1 to 20 times, more preferably from 1 to 15 times, and still more preferably from 1 to 10 times.

The hydrocarbon solvent that is liquid at room temperature used in the intermediate washing and the final washing is preferably an aromatic hydrocarbon compound or a saturated hydrocarbon compound that is liquid at room temperature (20° C.); so specifically, this is preferably an aromatic hydrocarbon compound such as toluene, xylene, and ethylbenzene, as well as a saturated hydrocarbon compound such as hexane, heptane, cyclohexane, and methylcyclohexane. It is preferable that an aromatic hydrocarbon compound is used in the intermediate washing, and that a saturated hydrocarbon compound is used in the final washing.

The ratio of the amount of each component to be used in the production of the solid catalyst component for olefin polymerization containing the succinate diester compound and the phthalate diester compound varies depending on the preparation method, so that this may not be generally specified. For example, to 1 mole of the magnesium compound, it is preferable that the total mole number of the succinate diester compound represented by the general formula (1) and the phthalate diester compound represented by the general formula (2) is preferably from 0.01 to 10 moles, more preferably from 0.01 to 1 mole, and still more preferably from 0.02 to 0.6 moles; the mole number of the tetravalent titanium halide compound is preferably from 0.5 to 100 moles, more preferably from 0.5 to 50 moles, and still preferably from 1 to 10 moles; and the mole number of the inert organic solvent is preferably from 0.001 to 500 moles, more preferably from 0.001 to 100 moles, and especially preferably from 0.005 to 10 moles.

In the preparation method described above, in addition to the succinate diester compound represented by the general formula (1) and the phthalate diester compound represented by the general formula (2), other internal electron-donating compound may be used in combination with these diester compounds. Further, the afore-mentioned contact may be conducted in the presence of other reaction reagent such as silicon, phosphorus, aluminum, as well as a surfactant.

In the production method of the solid catalyst component for olefin polymerization containing the succinate diester compound and the phthalate diester compound, a suitable embodiment of the solid catalyst component for olefin polymerization containing the succinate diester compound and the phthalate diester compound to be obtained has already been explained in detail in the description of the solid catalyst component for olefin polymerization containing the succinate diester compound and the phthalate diester compound.

In the olefin polymerization catalyst according to the present invention, the mass ratio (S/P) of the content(S) of the succinate diester compound represented by the general formula (1) to the content (P) of the phthalate diester compound represented by the general formula (2) in the solid catalyst component for olefin polymerization containing the succinate diester compound and the phthalate diester compound is preferably from 1/99 to 50/50, and more preferably from 5/95 to 40/60. When the mass ratio (S/P) is within the above-mentioned range, a polymer having a high flexural modulus may be obtained by polymerization.

The olefin polymerization catalyst according to the present invention contains (II) an organoaluminum compound.

In the olefin polymerization catalyst according to the present invention, (II) the organoaluminum compound is an organoaluminum compound represented by the following general formula (6):

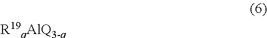

(in the formula, R¹⁹ represents an alkyl group having the carbon number of 1 to 6, Q is a hydrogen atom or a halogen atom, and q represents the number 0<q≤3, in which when there are a plurality of R¹⁹, these R¹⁹ are optionally identical or different from each other, and when there are a plurality of Q, these Q are optionally identical or different from each other).

In the organoaluminum compound represented by the general formula (6), q represents the number 0<q≤3, and specifically q is 1, 2, or 3.

Examples of (II) the organoaluminum compound may include specifically one or more compounds selected from: trialkylaluminum such as triethylaluminum, triisopropylaluminum, tri-n-butylaluminum, tri-n-hexylaluminum, and triisobutylaluminum; alkylaluminum halides such as diethylaluminum chloride and diethylaluminum bromide; and diethylaluminum hydride. Among these, one or more compounds selected from an alkylaluminum halide such as diethylaluminum chloride, as well as trialkylaluminum such as triethylaluminum, tri-n-butylaluminum, and triisobutylaluminum are preferable. One or more compounds selected from triethylaluminum and triisobutylaluminum are more preferable.

The olefin polymerization catalyst according to the present invention includes, as (III) the external electron-donating compound, at least an alkoxysilane compound represented by the general formula (3) and an (alkylamino)alkylsilane compound represented by the general formula (4).

The olefin polymerization catalyst according to the present invention contains, as the external electron-donating compound, at least one compounds selected from alkoxysilane compounds represented by the following general formula (3):

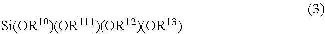

(in the formula, R¹⁰, R¹¹, R¹², and R¹³, all of which are optionally identical or different from each other, are a linear alkyl group having the carbon number of 1 to 8 or a branched alkyl group having the carbon number of 3 to 8).

In the alkoxysilane compound represented by the general formula (3), R¹⁰, R¹¹, R¹², and R¹³, all of which are optionally identical or different from each other, are a linear or a branched alkyl group having the carbon number of 1 to 8, and preferably the carbon number of 1 to 4.

When R¹⁰, R¹¹, R¹², and R¹³ are a linear or a branched alkyl group having the carbon number of 1 to 4, specifically, the alkyl group may include a methyl group, an ethyl group, an n-propyl group, an isopropyl group, an n-butyl group, and an isobutyl group.

There is no particular restriction in the alkoxysilane compound represented by the general formula (3); illustrative examples thereof may include tetramethoxysilane, tetraethoxysilane, tetra-n-propoxysilane, and tetraisopropoxysilane; among these, tetraethoxysilane and tetra-n-propoxysilane are preferable.

The olefin polymerization catalyst according to the present invention includes, as the external electron-donating compound, one or more compounds selected from (alkylamino)alkylsilane compounds represented by the following general formula (4):

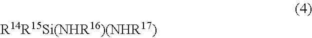

(in the formula, R¹⁴ and R¹⁵, which are optionally identical or different from each other, are a linear alkyl group having the carbon number of 1 to 8, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20; and R¹⁶ and R¹⁷, which are optionally identical or different from each other, are an alkyl group having the carbon number of 1 to 8).

In the (alkylamino)alkylsilane compound represented by the general formula (4), R¹⁴ and R¹⁵, which are optionally identical or different from each other, are a linear alkyl group having the carbon number of 1 to 8, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20. They are preferably a linear alkyl group having the carbon number of 1 to 6, a branched alkyl group having the carbon number of 3 to 8, or a cycloalkyl group having the carbon number of 3 to 8.

R¹⁴ and R¹⁵ may include a methyl group, an ethyl group, an n-propyl group, an isopropyl group, an n-butyl group, an isobutyl group, a neopentyl group, a cyclopentyl group, an n-hexyl group, a cyclohexyl group, and a 2-ethylhexyl group.

In the (alkylamino)alkylsilane compound represented by the general formula (4), R¹⁶ and R¹⁷, which are optionally identical or different from each other, are an alkyl group having the carbon number of 1 to 8, preferably a linear alkyl group having the carbon number of 1 to 6, or a branched alkyl group having the carbon number of 3 to 6.

R¹⁶ and R¹⁷ may include a methyl group, an ethyl group, an n-propyl group, an isopropyl group, an n-butyl group, an isobutyl group, an n-pentyl group, a neopentyl group, an n-hexyl group, and a cyclohexyl group.

The (alkylamino)alkylsilane compound represented by the general formula (4) may include specifically diisopropyl bis(ethylamino) silane, dicyclopentyl bis(ethylamino) silane, dicyclohexyl bis(ethylamino) silane, cyclohexyl methyl bis(ethylamino) silane, and cyclohexyl cyclopentyl bis(ethylamino) silane.

In the olefin polymerization catalyst according to the present invention, a molar ratio (Y/X) of the content (Y) of the (alkylamino)alkylsilane compound represented by the general formula (4) to the content (X) of the alkoxysilane compound represented by the general formula (3) is preferably from 1/99 to 50/50, and more preferably from 10 90 to 30/70.

The olefin polymerization catalyst according to the present invention includes (I) the solid catalyst component for olefin polymerization containing the succinate diester compound and the phthalate diester compound, (II) the organoaluminum compound, and as (III) the external electron-donating compound, at least the alkoxysilane compound represented by the general formula (3) and the (alkylamino)alkylsilane compound represented by the general formula (4); in other words, the catalyst is the contact product of these compounds.

The olefin polymerization catalyst according to the present invention may include the catalyst that is prepared by contacting, in the absence of an olefin, (I) the solid catalyst component for olefin polymerization containing the succinate diester compound and the phthalate diester compound, (II) the organoaluminum compound, and as (III) the external electron-donating compound, the alkoxysilane compound represented by the general formula (3) and the (alkylamino)alkylsilane compound represented by the general formula (4), or the catalyst obtained by contacting these compounds in the presence of an olefin (in a polymerization system), which is going to be described later.

In the olefin polymerization catalyst according to the present invention, there is no particular restriction in the content ratio of each component as long as it does not adversely affect the advantageous effects of the present invention. In general, the content of (II) the organoaluminum compound relative to total 1 mole of the titanium atom in (I) the solid catalyst component for olefin polymerization containing the succinate diester compound and the phthalate diester compound is preferably from 1 to 2000 moles, and more preferably from 50 to 1000 moles. Also, in the olefin polymerization catalyst according to the present invention, the total mole number of the alkoxysilane compound represented by the general formula (3) and the (alkylamino)alkylsilane compound represented by the general formula (4), which are (III) the external electron-donating compounds, relative to 1 mole of (II) the organoaluminum compound is preferably from 0.002 to 10.000 moles, more preferably from 0.010 to 2.000 moles, and still more preferably from 0.010 to 0.500 moles.

The inventors of the present invention have found that the olefin polymerization catalyst using the olefin polymerization solid catalyst component that uses, as the internal electron-donating compound, only the succinate diester gives a polymer having a high flexural modulus (FM), but also have found that it is necessary to increase the amount of hydrogen to be used in order to increase a melt flowability (melt flow rate: MFR). The inventors then have found that the increased amount of hydrogen to be used leads to the formation of low molecular weight polymer components, which in turn leads to poor dispersion of an ethylene-propylene rubber component, resulting in a low impact resistance (IZOD).

The inventors of the present invention have further found that when at the time of olefin polymerization both the solid catalyst component for olefin polymerization using, as the internal electron-donating compound, only the succinate diester compound and the solid catalyst component for olefin polymerization using, as the internal electron-donating compound, only the phthalate diester compound are used together with the alkoxysilane compound represented by the general formula (3) as the external electron-donating compound, a polymer having a high melt flow rate (MFR) can be obtained even when the amount of hydrogen to be used is small.

Based on this finding, the inventors of the present invention have found that by using the succinate diester compound in combination with the phthalate diester compound as the internal electron-donating compounds in the solid catalyst component for olefin polymerization that constitutes the olefin polymerization catalyst, while suitably increasing the melt flow rate (MFR) of the resulting olefin polymer, a molecular weight distribution of an olefin polymer becomes wider and a very high molecular weight polymer component can be formed; and while increasing the flexural modulus (FM) of the olefin polymer, a polymer having a high melt flowability (MFR) can be obtained.

In the olefin polymerization catalyst according to the present invention, simultaneously with the solid catalyst component for olefin polymerization as described above, by combined use of, as the external electron-donating compounds that constitute the olefin polymerization catalyst, the (alkylamino)alkylsilane compound represented by the general formula (4) and the alkoxysilane compound represented by the general formula (3), an olefin polymer having a high melt flowability (MFR) can be obtained even with the reduced amount of hydrogen to be used, while keeping the polymerization activity and the hydrogen-responding property both at high levels with reducing the amount of the xylene-dissolvable component (XS) in the polymer.

Therefore, when the olefin polymerization catalyst according to the present invention is used for production of an olefin polymer, an olefin polymer having the melt flow rate (MFR) required for molding can be obtained with a smaller amount of hydrogen to be used than before, thereby enabling to reduce the formation of a low molecular weight polymer component. It is presumed that because of this the dispersibility of the ethylene-propylene rubber component is increased, and thus, when compared under similar polymerization conditions, a polymer having the flexural modulus (FM) and the impact resistance (IZOD) increased can be obtained.

The method for producing an olefin polymer according to the present invention is characterized in that an olefin is polymerized using the olefin polymerization catalyst according to the present invention, for example.

In the method for producing an olefin polymer according to the present invention, the polymerization of an olefin may include any of homo-polymerization and copolymerization.

In the method for producing an olefin polymer according to the present invention, the olefin used for polymerization may include one olefin or combinations of two or more olefins selected from ethylene, propylene, 1-butene, 1-pentene, 4-methyl-1-pentene, and vinyl cyclohexane. Among them, as the olefin used for polymerization, ethylene and propylene are preferable.

When the olefin polymerization catalyst according to the present invention is prepared in the presence of an olefin (in the polymerization system), there is no particular restriction in the ratio of the amount of each component to be used as long as it does not adversely affect the advantageous effects of the present invention. In general, it is preferable to contact (II) the above-mentioned organoaluminum compound of 1 to 2000 moles, and more preferably 50 to 1000 moles to 1 mole of total titanium atom in (I) the above-mentioned solid catalyst component for olefin polymerization. Also, it is preferable that 0.002 to 10.000 moles of (III) the above-mentioned external electron-donating compounds are contacted with 1 mole of (II) the organoaluminum compound; this is more preferably from 0.010 to 2.000 moles, and still more preferably from 0.010 to 0.500 moles.

Although the order of the contact of each component that constitutes the olefin polymerization catalyst according to the present invention is arbitrary, it is preferable to charge firstly (II) the organoaluminum compound into the polymerization system, followed by charging and contacting (III) the external electron-donating compounds, and then charging and contacting (I) the solid catalyst component for olefin polymerization.

The method for producing an olefin polymer according to the present invention may be carried out in the presence or absence of an organic solvent.

An olefin monomer such as propylene may be used in any of a gaseous state and a liquid state. The polymerization temperature is preferably 200° C. or less, and more preferably 100° C. or less. The pressure at the time of polymerization is preferably 10 MPa or less, and more preferably 5 MPa or less. Polymerization of an olefin may be carried out by any of a continuous polymerization method and a batch polymerization method. The polymerization reaction may be carried out in one stage or in two stages or more.

In addition, when conducting the olefin polymerization using the olefin polymerization catalyst according to the present invention (also called main polymerization), it is preferable to conduct prepolymerization prior to the main polymerization in order to further enhance the properties such as a catalytic activity, a stereo-regularity, and a particle property of the resulting polymer. In the prepolymerization, the same olefin as the olefin to be used in the main polymerization, or a monomer such as styrene may be used.

At the time of prepolymerization, the contacting order of each component that constitutes the olefin polymerization catalyst according to the present invention and the monomer (olefin) is arbitrary. However, in the prepolymerization system set in an inert gas or in an olefin gas atmosphere, it is preferable that (II) the organoaluminum compound is charged firstly, then (III) the external electron-donating compounds are charged and contacted, followed by charging and contacting (I) the solid catalyst component for olefin polymerization, and then contacting a mixture of an olefin such as propylene with at least one other olefin.

In the method for producing an olefin polymer according to the present invention, the polymerization method may include a slurry polymerization method using an inert hydrocarbon compound solvent such as cyclohexane and heptane, a bulk polymerization method using a solvent such as a liquefied propylene, and a vapor phase polymerization method using substantially no solvent; among these, the bulk polymerization method and the vapor phase polymerization method are preferable.

In the case of copolymerization of propylene and other α-olefin monomer, typically there are random copolymerization in which propylene and a small amount of ethylene as a comonomer are polymerized in one stage, and a so-called propylene-ethylene block copolymerization in which propylene is solely polymerized in the first stage (first polymerization reactor) and then propylene is copolymerized with other α-olefin such as ethylene in the second stage (second polymerization reactor) or in multiple steps (multi-stage polymerization reactor). Here, the block copolymerization of propylene and other α-olefin is preferable.

The block copolymer obtained by the block copolymerization is a polymer containing segments of continuously varying monomer compositions of two types or more, in which two or more polymer chains (segments) having different primary structures such as a monomer species, a comonomer species, a comonomer composition, a comonomer content, a comonomer arrangement, and a steric regularity are bonded in one molecular chain.

In the method for producing an olefin polymer according to the present invention, the block copolymerization reaction of propylene with other α-olefin is usually carried out in the presence of (A) the olefin polymerization catalyst in the first half stage by contacting solely propylene, or propylene and a small amount of an α-olefin (e.g., ethylene), followed by contacting propylene with the α-olefin (e.g., ethylene) in the second half stage. The polymerization reaction may be carried out by a multi-stage reaction, in which the polymerization reaction in the first half stage may be repeated multiple times, or the polymerization reaction in the second half stage may be repeated multiple times.

In the block copolymerization reaction of propylene with other α-olefin, specifically, it is preferable to carry out the polymerization in such a way that in the first half stage the polymerization is carried out with controlling the polymerization temperature and time so as to result in the ratio of the polypropylene moiety (in the copolymer finally obtained) from 20 to 90% by mass, then in the second half stage, propylene as well as ethylene or other α-olefin are charged so as to result in the ratio of a rubber moiety such as an ethylene-propylene rubber (EPR) from 10 to 80% by mass (in the copolymer finally obtained).

The polymerization temperatures in both the first half and the second half stages are preferably 200° C. or less, more preferably 100° C. or less, still more preferably from 65° C. to 80° C., and further still more preferably from 75 to 80° C. The pressure at the time of the polymerization is preferably 10 MPa or less, more preferably 6 MPa or less, and still more preferably 5 MPa or less.

In the polymerization reaction, any of a continuous polymerization method and a batch polymerization method may be used, and the polymerization reaction may be conducted in one stage or two stages or more.

The polymerization time (residence time in the reactor) is preferably from 1 minute to 5 hours in each polymerization stage of the first half stage and the second half stage, or in the continuous polymerization, too.

The polymerization method may include a slurry polymerization method using an inert hydrocarbon compound solvent such as cyclohexane and heptane, a bulk polymerization method using a solvent such as liquefied propylene, and a vapor phase polymerization method substantially not using a solvent. Among these, the bulk polymerization method and the vapor phase polymerization method are preferable.

In the method for producing an olefin polymer according to the present invention, a hydrogen gas and an olefin are charged with the ratio such that the melt flowability (MFR) of the propylene polymer obtained in the homo-stage polymerization will be 350 g/10-minutes or less. When the hydrogen gas and olefin are charged with the ratio as mentioned above, an olefin polymer having a suitable melt flowability (MFR) can be obtained.

The melt flow rate (MFR) of the olefin homopolymer obtained with the method for producing an olefin polymer according to the present invention may be chosen as appropriate in accordance with the use thereof. The melt flow rate is, for example, from 0.1 to 1000 g/10-minutes, preferably from 10 to 500 g/10-minutes, and more preferably from 50 to 350 g/10-minutes.

Here, the melt flow rate (MFR) in this specification means the value measured by the method in accordance with ASTM D 1238 and JIS K 7210.

### EXAMPLES

Next, the present invention will be more specifically explained by means of Examples; but these are mere examples, not restricting the present invention.

### (Production Example 1) Synthesis of (I) Solid Catalyst Component for Olefin Polymerization Containing Succinate Diester Compound and Phthalate Diester Compound

By simultaneously using, as the internal electron-donating compounds, diethyl diisopropylsuccinate, which is the succinate diester compound, and dibutyl phthalate, which is the phthalate diester compound, the solid catalyst component for olefin polymerization was prepared by the method described below.
(i) Into a 500-mL flask equipped with a stirrer and completely purged with a nitrogen gas inside thereof, 20 mL (182.4 mmoles) of titanium tetrachloride and 40 mL of toluene were charged to form a mixed solution.
(ii) Next, a suspension solution obtained from 10.0 g (87.2 mmoles) of diethoxymagnesium, 45 mL of toluene, and 2.4 mL (9.0 mmoles) of dibutyl phthalate was charged into the above-prepared mixed solution while keeping the liquid temperature thereof at −6° C.
(iii) The temperature of the resulting initial contact product-containing solution was raised, and at 60° C. in the midway of the temperature raising, 1.2 mL (2.2 mmoles) of diethyl diisopropylsuccinate was added to the solution. After the temperature was further raised to 100° C., the reaction was carried out for 90 minutes while keeping this temperature. After completion of the reaction, the supernatant solution was withdrawn, and the first contact product, i.e., the reaction product, was washed with 85 mL of toluene at 100° C. four times.
(iv) Next, to the resulting first contact product, 84 mL of toluene and 16 mL (145.6 mmoles) of titanium tetrachloride were added; then, the temperature of the resulting mixture was raised to 110° C., at which temperature the reaction was carried out for 120 minutes. After completion of the reaction, the operation to withdraw the supernatant solution was repeated three times to obtain the final contact product.

Next, the resulting final contact product was washed with 70 mL of n-heptane at 40° C. eight times, then by conducting the solid-liquid separation, the solid catalyst component ((I) the solid catalyst component for olefin polymerization containing the succinate diester compound and the phthalate diester compound) was obtained.

The contents of titanium, dibutyl phthalate, and the succinate diester compound (ID) in the solid portion obtained by the solid-liquid separation of the solid catalyst component obtained were measured to be 1.81% by mass, 12.9% by mass, and 4.3% by mass, respectively.

The properties of (I) the solid catalyst component thereby obtained are described in Table 1.

The contents of titanium, diisopropyl succinate, i.e., the succinate diester compound, and dibutyl phthalate, i.e., the phthalate diester compound, both being the internal electron-donating compounds, in the solid catalyst component, as well as the physical properties thereof were measured by the methods described below.

### <Content of Titanium in Solid Catalyst Component>

The content of titanium in the solid catalyst component was measured by the method in accordance with JIS 8311-1997.

### <Content of Internal Electron-Donating Compound>

The content of the internal electron-donating compound was determined by a gas chromatography (manufactured by Shimadzu Corp., GC-2014) under the following conditions. The mole number of the internal electron-donating compound was determined from the result of the gas chromatography using a calibration curve measured in advance by using known concentrations.

### <Measurement Conditions>

Column: Capillary column (diameter of 0.32 mm, film thickness of 1.0 μm, Rxi-1 ms, manufactured by GL Sciences Inc.)

Detector: Flame Ionization Detector (FID; hydrogen flame ionization detector)

Carrier gas: Helium, flow rate of 7.0 ml/min

Measurement temperature: Vaporization chamber 280° C., column 170° C., detector 280° C.

### (Production Example 2) Synthesis of (a) Solid Catalyst Component for Olefin Polymerization Containing Succinate Diester Compound

By using diethyl diisopropylsuccinate, i.e., the succinate diester compound serving as the internal electron-donating compound, the solid catalyst component for olefin polymerization was prepared by the method described below.
(i) Into a 500-mL flask equipped with a stirrer and completely purged with a nitrogen gas inside thereof, 60 mL (545.8 mmoles) of titanium tetrachloride and 75 mL of toluene were charged to form a mixed solution.
(ii) Next, a suspension solution obtained from 30.0 g (262.2 mmoles) of diethoxymagnesium, 90 mL of toluene, and 4.5 mL (16.8 mmoles) of diethyl diisopropylsuccinate was charged into the above-prepared mixed solution while keeping its liquid temperature at −6° C.
(iii) The temperature of the resulting initial contact product-containing solution was raised, and at 60° C. in the midway of the temperature raising, 4.5 mL (16.8 mmoles) of diethyl diisopropylsuccinate was added to the solution. After the temperature was further raised to 100° C., the reaction was carried out for 90 minutes while keeping this temperature. After completion of the reaction, the supernatant solution was withdrawn, and the first contact product, i.e., the reaction product, was washed with 225 mL of toluene at 90° C. four times.
(iv) Next, to the resulting first contact product, 150 mL of toluene and 30 mL (272.9 mmoles) of titanium tetrachloride was added; then, the temperature of the resulting mixture was raised to 115° C., at which temperature the reaction was carried out for 60 minutes. After completion of the reaction, the operation to withdraw the supernatant solution was repeated three times to obtain the final contact product.

Next, the resulting final contact product was washed with 225 mL of n-heptane at 40° C. six times, then by conducting the solid-liquid separation, the solid catalyst component ((a) the solid catalyst component for olefin polymerization containing the succinate diester compound) was obtained.

The contents of titanium and of the succinate diester compound (ID) in the solid portion obtained by the solid-liquid separation of the solid catalyst component obtained were measured to be 3.08% by mass and 19.8% by mass, respectively.

### (Production Example 3) Synthesis of (b) Olefin Polymerization Catalyst Containing Phthalate Diester Compound

By using di-n-butyl phthalic phthalate, i.e., the phthalate diester compound as the internal electron-donating compound, the solid catalyst component for olefin polymerization was prepared by the method described below.
(i) Into a 500-mL flask equipped with a stirrer and completely purged with a nitrogen gas inside thereof, 105 mL (952.0 mmoles) of titanium tetrachloride and 75 mL of toluene were charged to form a mixed solution.
(ii) Next, a suspension solution obtained from 30.0 g (262.2 mmoles) of diethoxymagnesium, 135 mL of toluene, and 9.2 mL (39.5 mmoles) of di-n-butyl phthalate was charged into the above-prepared mixed solution while keeping the liquid temperature thereof at −10° C.
(iii) The above initial contact product-containing solution was set to the temperature of 110° C., and the reaction was carried out for 180 minutes while keeping this temperature. After completion of the reaction, the supernatant solution was withdrawn, and the first contact product, i.e., the reaction product, was washed with 250 mL of toluene at 100° C. four times.
(iv) Next, to the resulting first contact product, 185 mL of toluene and 30 mL (272.0 mmoles) of titanium tetrachloride were added; then, the temperature of the resulting mixture was raised to 110° C., at which temperature the reaction was carried out for 120 minutes to obtain the final contact product.

Next, the resulting final contact product was washed with 188 mL of n-heptane at 40° C. eight times, then by conducting the solid-liquid separation, (d) the solid catalyst component for olefin polymerization containing the phthalate diester compound was obtained.

The contents of titanium and of the phthalate diester compound in the solid portion obtained by the solid-liquid separation of the solid catalyst component obtained were measured to be 2.5% by mass and 12.2% by mass, respectively.

### Example 1

### <Preparation of External Donor Mixture and Ethylene-Propylene Copolymerization Catalyst>

After tetraethoxysilane and dicyclopentyl bis(ethylamino) were taken into a heat-resistant glass bottle having a stirrer tip therein with the molar ratio of 70:30, the resulting mixture was stirred and mixed using a magnetic stirrer and then diluted with n-heptane to obtain the external donor mixture.

Next, 2.2 mmoles of triethylaluminum, a total of 0.22 mmoles of the above-obtained external donor mixture in terms of silicon atom, and a total of 10.9 mg (0.0055 mmoles in terms of titanium atom) of (I) the afore-mentioned solid catalyst component were charged into an autoclave with an internal volume of 2.0 liters equipped with a stirrer and completely purged with a nitrogen gas to prepare an ethylene-propylene Copolymerization Catalyst.

### <Ethylene-Propylene Copolymerization>

Into the autoclave equipped with a stirrer containing the above-prepared ethylene-propylene Copolymerization Catalyst, 15 moles of liquefied propylene (1.2 liters) and 0.20 MPa of a hydrogen gas (partial pressure) were charged. After prepolymerization was carried out at 20° C. for 5 minutes, the temperature was raised, and the first-stage propylene homo-polymerization reaction (homo-stage polymerization) was carried out at 70° C. for 45 minutes. After the pressure was resumed to a normal pressure and the inside the autoclave (inside the reactor) was purged with a nitrogen gas, the autoclave was weighed; then the weight of the empty autoclave was subtracted from this weight; by so doing, the homo-stage (first stage) polymerization activity (homo-activity, g-PP/g-cat) was calculated.

Some of the polymer produced were taken for evaluation of the polymerization performance and of physical properties of the polymer.

Next, ethylene/propylene were charged into the autoclave (into the reactor) with the molar ratio of 1.5/1.0, then after the temperature was raised to 70° C., the reaction was carried out at 1.2 MPa and 70° C. with charging ethylene/propylene/hydrogen into the autoclave at the gas supply rate per one minute (liter/min) of 1.6/2.4/0.09 to obtain the ethylene-propylene copolymer.

### <Polymerization Activity Per 1 Gram of Solid Catalyst Component>

The polymerization activity per 1 gram of the solid catalyst component was determined from the following formula:

$$Polymerization activity ( g / g - cat ) = mass of polymer ( g ) / mass of solid catalyst component ( g )$$

### <Melt Flow Rate (MFR)>

The melt flow rate (MFR) of the olefin polymer was measured by the method in accordance with ASTM D 1238 and JIS K 7210.

### <Block Ratio (% by Mass)>

The block ratio of ethylene-propylene copolymer was calculated using the following formula (8):

$$Block ratio ( \% by mass ) = \{ ( I ( g ) - G ( g ) ) / ( I ( g ) - F ( g ) ) \} \times 100 \qquad ( 8 )$$

In the formula, I is the autoclave mass (g) after the copolymerization reaction is completed, G is the autoclave mass (g) after the homo-polymerization of propylene is completed and unreacted monomer is removed, and F is the autoclave mass (g).

### <Flexural Modulus (FM)>

The injection-molded test piece of the olefin polymer having the thickness of 4.0 mm, the width of 10.0 mm, and the length of 170.0 mm was prepared at the molding temperature of 180° C. and the die temperature of 40° C. using NEX-III-3EG manufactured by Nissei Plastic Industrial Co., Ltd., and the flexural modulus (FM) of the test piece was measured at the atmospheric temperature of 23° C. by the method in accordance with JIS K7171 (unit: MPa).

### <Impact Resistance (IZOD)>

The impact resistance (IZOD) of the olefin polymer was measured by the method in accordance with JIS K 7110 (“Method of Izod Impact Test For Rigid Plastics”) (unit: KJ/m2).

First, 0.10% by weight of IRGANOX 1010 (manufactured by BASF GmbH) and 0.10% by weight of IRGAFOS 168 (manufactured by BASF GmbH) were added to the ethylene-propylene copolymer, and the resulting mixture was kneaded and granulated in a biaxial kneader to obtain ethylene-propylene copolymer pellets. The resulting ethylene-propylene copolymer pellets were charged into an injection molding machine (the die temperature of 40° C. and the cylinder temperature of 180° C.) to carry out the injection molding to obtain a test piece for measurement of the properties thereof. The resulting test piece was cut out to make a specimen, which was then processed as described below. After this was allowed to be conditioned in a temperature-controlled chamber maintained at 23° C. for at least 72 hours, the Izod impact strength of the specimen was measured using an impact tester No. 258-L (equipped with a low-temperature chamber) manufactured by Yasuda Seiki Seisakusho Ltd.
Shape of specimen: ISO 180/1A, thickness of 4.0 mm, width of 8.0 mm, and length of 80.0 mm
Shape of notch: A-type notch (radius: 0.25 mm) formed by using a die equipped with a notch.
Temperature: 23° C.
Impact velocity: 3.5 m/sec
Nominal pendulum energy: 2.75 J (23° C.)

### Comparative Example 1

Preparation of the ethylene-propylene Copolymerization Catalyst and ethylene-propylene copolymerization were carried out in the same way as in Example 1 to obtain an ethylene-propylene copolymer, except that as the solid catalyst component, in place of (I) the solid catalyst component for olefin polymerization containing the succinate diester compound and the phthalate diester compound, (b) the solid catalyst component for olefin polymerization containing the phthalate diester compound was used.

### Comparative Example 2

Preparation of the ethylene-propylene Copolymerization Catalyst was carried out in the same way as in Example 1 to obtain an ethylene-propylene Copolymerization Catalyst, except that as the solid catalyst component, in place of (I) the solid catalyst component for olefin polymerization containing the succinate diester compound and the phthalate diester compound, (a) the solid catalyst component for olefin polymerization containing the succinate diester compound was used; and in the ethylene-propylene copolymerization, the ethylene-propylene copolymerization was carried out in the same way as Example 1 to obtain an ethylene-propylene copolymer, except that reaction was carried out with the ethylene/propylene/hydrogen gas feed rate per 1 minute of 1.6/2.4/0.11 (liters/minute).

TABLE 1

| | Homo activity | Homo MFR | ICP activity | Block ratio | ICP MFR | FM | IZOD |
|---|---|---|---|---|---|---|---|
| | (g-PP/g-cat) | (g/10 min) | (g-ICP/g-cat) | (% by mass) | (g/10 min) | (MPa) | (kJ/m²) |
| Example 1 | 21900 | 210 | 9800 | 31.0 | 22 | 1140 | 43 |
| Comparative | 28000 | 350 | 12100 | 30.1 | 30 | 880 | 44 |
| Example 1 | | | | | | | |
| Comparative | 23500 | 68 | 7300 | 23.7 | 9.8 | 1510 | 5 |
| Example 2 | | | | | | | |

### INDUSTRIAL APPLICABILITY

According to the present invention, even when the amount of hydrogen used in polymerization is small, a sufficient melt flowability can be obtained, so that an olefin polymer having a high flexural modulus and a high impact resistance can be produced as compared with those obtained using a conventional olefin polymerization catalyst when compared under the same polymerization condition; as a result, the olefin polymer can be produced at a low cost.

1. An olefin polymerization catalyst comprising:
(I) a solid catalyst component for olefin polymerization containing at least magnesium, titanium, halogen, and as an internal electron-donating compound, at least one or more compounds selected from succinate diester compounds represented by the following general formula (1): 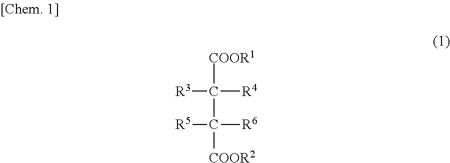
in the formula, R¹ and R² each, which are optionally identical or different from each other, independently represent a linear alkyl group having the carbon number of 1 to 12, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20; R³, R⁴, R⁵, and R⁶ each, all of which are optionally identical or different from each other, independently represent an atom or a group selected from a hydrogen atom, a halogen atom, a linear alkyl group having the carbon number of 1 to 12, a branched alkyl group having the carbon number of 3 to 12, a vinyl group, a linear or a branched alkenyl group having the carbon number of 3 to 12, a linear or a branched halogen-substituted alkyl group having the carbon number of 2 to 12, a cycloalkyl group having the carbon number of 3 to 12, a cycloalkenyl group having the carbon number of 3 to 12, an aromatic hydrocarbon group having the carbon number of 6 to 20, a nitrogen-containing group, a phosphorus-containing group, and a silicon-containing group, and
one or more compounds selected from phthalate diester compounds represented by the following general formula (2): 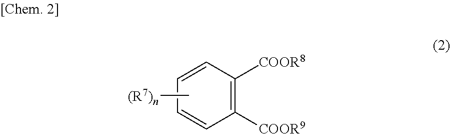
in the formula, R⁷ represents an alkyl group having the carbon number of 1 to 8 or a halogen atom, R⁸ and R⁹, which are optionally identical or different from each other, represent an alkyl group having the carbon number of 1 to 12, and the number n of the substituent R⁷ represents 0, 1, or 2, in which when n is 2, these R⁷ are optionally identical or different from each other;
(II) an organoaluminum compound; and
(III) as an external electron-donating compound, at least one or more compounds selected from alkoxysilane compounds represented by the following general formula (3): 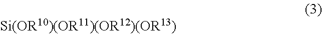
in the formula, R¹⁰, R¹¹, R¹², and R¹³, all of which are optionally identical or different from each other, represent a linear alkyl group having the carbon number of 1 to 8 or a branched alkyl group having the carbon number of 3 to 8, and
one or more compounds selected from (alkylamino)alkylsilane compounds represented by the following general formula (4): 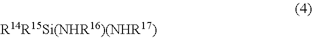
in the formula, R¹⁴ and R¹⁵, which are optionally identical or different from each other, represent a linear alkyl group having the carbon number of 1 to 8, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20; and R¹⁶ and R¹⁷, which are optionally identical or different from each other, represent an alkyl group having the carbon number of 1 to 8.

2. The olefin polymerization catalyst according to claim 1, wherein the succinate diester compound represented by the general formula (1) is at least one selected from the group consisting of diethyl succinate, diethyl 2,3-dimethylsuccinate, diethyl 2,3-diethylsuccinate, diethyl 2,3-di-n-propylsuccinate, diethyl 2,3-diisopropylsuccinate, diethyl 2,3-di-n-butylsuccinate, diethyl 2,3-diisobutylsuccinate, diisobutyl 2,3-diisopropylsuccinate, di-n-butyl 2,3-diisopropylsuccinate, diethyl 2,3-dicyclohexyl-2-methylsuccinate, diisobutyl 2,3-dicyclohexyl-2-methylsuccinate, diethyl 2,3-diisopropyl-2-cyanosuccinate, di-n-butyl 2,3-diisopropyl-2-cyanosuccinate, di-n-butyl 2,3-diisopropyl-2-cyanosuccinate, diisobutyl 2,3-diisopropyl-2-cyanosuccinate, diethyl 2,3-dicyclopentyl-2-cyanosuccinate, di-n-butyl 2,3-dicyclopentyl-2-cyanosuccinate, diisobutyl 2,3-dicyclopentyl-2-cyanosuccinate, diethyl 2,3-dicyclohexyl-2-cyanosuccinate, di-n-butyl 2,3-dicyclohexyl-2-cyanosuccinate, diisobutyl 2,3-dicyclohexyl-2-cyanosuccinate, diethyl 2-cyclopentyl-3-cyclohexyl-2-cyanosuccinate, 1-isobutyl 4-ethyl 2,3-diisopropyl-2-cyanosuccinate, 1-n-butyl 4-ethyl 2,3-diisopropyl-2-cyanosuccinate, diethyl 2-isopropyl-3-methyl-2-cyanosuccinate, diethyl 2-isopropyl-3-ethyl-2-cyanosuccinate, diethyl 2-isopropyl-3-n-propyl-2-cyanosuccinate, diethyl 2-isopropyl-3-butyl-2-cyanosuccinate, diethyl 2-isopropyl-3-phenyl-2-cyanosuccinate, diethyl 2-cyclohexyl-3-isopropyl-2-cyanosuccinate, and 1-ethyl 4-isobutyl 2-isopropyl-3-phenyl-2-cyanosuccinate.

3. The olefin polymerization catalyst according to claim 1, wherein the phthalate diester compound represented by the general formula (2) is at least one selected from the group consisting of dimethyl phthalate, diethyl phthalate, di-n-propyl phthalate, diisopropyl phthalate, di-n-butyl phthalate, diisobutyl phthalate, ethyl methyl phthalate, methyl (isopropyl) phthalate, ethyl (n-propyl) phthalate, ethyl (n-butyl) phthalate, ethyl (isobutyl) phthalate, di-n-pentyl phthalate, diisopentyl phthalate, dineopentyl phthalate, dihexyl phthalate, di-n-heptyl phthalate, di-n-octyl phthalate, bis(2,2-dimethylhexyl) phthalate, bis(2-ethylhexyl) phthalate, di-n-nonyl phthalate, diisodecyl phthalate, bis(2,2-dimethylheptyl) phthalate, n-butyl (isohexyl) phthalate, n-butyl(2-ethylhexyl) phthalate, n-pentyl hexyl phthalate, n-pentyl (isohexyl) phthalate, isopentyl (heptyl) phthalate, n-pentyl(2-ethylhexyl) phthalate, n-pentyl (isononyl) phthalate, isopentyl (n-decyl) phthalate, n-pentyl undecyl phthalate, isopentyl (isohexyl) phthalate, n-hexyl (2,2-dimethylhexyl) phthalate, n-hexyl(2-ethylhexyl) phthalate, n-hexyl (isononyl) phthalate, n-hexyl (n-decyl) phthalate, n-heptyl(2-ethylhexyl) phthalate, n-heptyl (isononyl) phthalate, n-heptyl (neodecyl) phthalate, and 2-ethylhexyl (isononyl) phthalate.

4. The olefin polymerization catalyst according to claim 1, wherein the alkoxysilane compound represented by the general formula (3) is at least one selected from the group consisting of tetramethoxysilane, tetraethoxysilane, tetra (n-propoxy) silane, tetraisopropoxysilane, tetra (n-butoxy) silane, tetraisobutoxysilane, and tetrakis (2-ethylhexyloxy) silane.

5. The olefin polymerization catalyst according to claim 1, wherein the (alkylamino)alkylsilane compound represented by the general formula (4) is at least one selected from the group consisting of diisopropyl bis(ethylamino) silane, dicyclopentyl bis(ethylamino) silane, dicyclohexyl bis(ethylamino) silane, cyclohexylmethyl bis(ethylamino) silane, and cyclohexylcyclopentyl bis(ethylamino) silane.

6. The olefin polymerization catalyst according to claim 1, wherein a molar ratio (Y/X) of a content (Y) of the (alkylamino)alkylsilane compound represented by the general formula (4) to a content (X) of the alkoxysilane compound represented by the general formula (3) is from 1/99 to 50/50.

7. A method for producing an olefin polymer, the method comprising polymerizing an olefin using the olefin polymerization catalyst according to claim 1.
